(19) United States
(12) Patent Application Publication
(10) Pub. No.: US 2026/0192680 A1
(43) Pub. Date: Jul. 9, 2026

(54) STRATEGY FOR ADVANCED FORECASTING AND RANGE ESTIMATION IN ELECTRIFIED VEHICLES

(71) Applicant: FCA US LLC, Auburn Hills, MI (US)

(72) Inventor: Matthew C Robinson, Auburn Hills, MI (US)

(21) Appl. No.: 19/014,356

(22) Filed: Jan. 9, 2025

(51) Int. Cl. B60L 3/12; B60L 1/00; B60L 58/00

(52) U.S. Cl. CPC B60L 3/12; B60L 1/00; B60L 58/00; B60L 2260/52; B60L 2260/54

(57) ABSTRACT

An advanced forecasting and range estimation system for an electrified vehicle includes an electrified powertrain of the electrified vehicle, the electrified powertrain including at least one electric motor and an energy storage system and a control system of the electrified vehicle, the control system being configured to access navigation data for a future trip of the electrified vehicle and past or historical data for past trips of the electrified vehicle, calculate a weighted blend of a predicted road load power and a historic average road load power to obtain an estimation of a propulsive energy consumption rate for the electrified vehicle, calculate an estimation for a non-propulsive energy consumption rate based on base power consumption and feedback controller action, and estimate a final remaining range of the electrified vehicle based on the estimated propulsive and non-propulsive energy consumption rates.

### FIELD

The present application generally relates to electrified vehicles and, more particularly, to a strategy for advanced forecasting and remaining range estimation in electrified vehicles.

### BACKGROUND

Electrified vehicles (BEVs, PHEVs, etc.) include an energy storage system (e.g., a high voltage battery pack or system, a fuel cell system, or some combination thereof) that is capable of storing a finite amount of energy. The remaining amount of energy in the energy storage system directly affects a remaining range of the electrified vehicle. Accurate range estimation is critical for customer satisfaction and acceptance/adoption of electrified vehicles. Conventional solutions for range estimation are only based on historical (past) data, such as the vehicle's energy consumption over a previous distance or period of time. This historical-data-based range estimation, however, can be very inaccurate as the vehicle's future usage could widely differ from its past usage. For example, weather/temperature conditions could vary, and the vehicle's expected route/trip could be very different than its past routes/trips. Accordingly, while such conventional electrified vehicle range estimation systems do work for their intended purpose in some driving missions, there exists significant opportunity for improvement in the relevant art.

### SUMMARY

According to one example aspect of the invention, an advanced forecasting and range estimation system for an electrified vehicle is presented. In one exemplary implementation, the advanced forecasting and range estimation system comprises an electrified powertrain of the electrified vehicle, the electrified powertrain including at least one electric motor and an energy storage system and configured to generate propulsive power to propel the electrified vehicle and a control system of the electrified vehicle, the control system being configured to determine a predicted road load power for a future trip of the electrified vehicle, determine a historic average road load power based on the past or historical data, calculate a weighted blend of the predicted road load power and the historic average road load power to obtain a propulsive power demand for the electrified vehicle, and estimate a final remaining range of the electrified vehicle based on the propulsive power demand.

In some implementations, the control system is further configured to estimate a non-propulsive power demand of the electrified vehicle and estimate the final remaining range of the electrified vehicle based on both the propulsive and non-propulsive power demands. In some implementations, the control system is further configured to determine the predicted road load power based on a dynamic road load.

In some implementations, the control system is further configured to determine the dynamic road load based on a road load force model. In some implementations, the control system is further configured to apply a saturation threshold to weight historic and future propulsive power estimation. In some implementations, the control system is further configured to determine the historic average road load power based on vehicle speed and vehicle odometer data. In some implementations, the control system is further configured to perform a sliding window binning of the vehicle speed based on vehicle odometer data before thereafter calculating the historic average load power.

In some implementations, the control system is further configured to determine the predicted road load power based on available navigation data for the future trip of the electrified vehicle. In some implementations, the propulsive power demand corresponds to the electrified powertrain and not to a set of non-propulsive vehicle systems.

According to another example aspect of the invention, an advanced forecasting and range estimation method for an electrified vehicle is presented. In one exemplary implementation, the advanced forecasting and range estimation method comprises providing an electrified powertrain of the electrified vehicle, the electrified powertrain including at least one electric motor and an energy storage system and configured to generate propulsive power to propel the electrified vehicle, determining, by a control system of the electrified vehicle, a predicted road load power for a future trip of the electrified vehicle, determining, by the control system, a historic average road load power based on the past or historical data, calculating, by the control system, a weighted blend of the predicted road load power and the historic average road load power to obtain a propulsive power demand for the electrified vehicle, and estimating, by the control system, a final remaining range of the electrified vehicle based on the propulsive and non-propulsive power demands.

In some implementations, advanced forecasting and range estimation method further comprises estimating, by the control system, a non-propulsive power demand of the electrified vehicle and estimating, by the control system, the final remaining range of the electrified vehicle based on both the propulsive and non-propulsive power demands. In some implementations, the determining of the predicted road load power is based on a dynamic road load.

In some implementations, the determining of the dynamic road load is based on a road load force model. In some implementations, the advanced forecasting and range estimation method further comprises applying, by the control system, a saturation threshold to weight historic and future propulsive power estimation. In some implementations, the historic average road load power is determined based on vehicle speed and vehicle odometer data. In some implementations, the advanced forecasting and range estimation method further comprises performing, by the control system, a sliding window binning of the vehicle speed based on vehicle odometer data before thereafter calculating the historic average load power.

In some implementations, the determining of the predicted road load power is based on available navigation data for the future trip of the electrified vehicle. In some implementations, the propulsive power demand corresponds to the electrified powertrain and not to a set of non-propulsive vehicle systems.

According to another example aspect of the invention, another advanced forecasting and range estimation system for an electrified vehicle is presented. In one exemplary implementation, the advanced forecasting and range estimation system comprises an electrified powertrain of the electrified vehicle, the electrified powertrain including at least one electric motor and an energy storage system and a control system of the electrified vehicle, the control system being configured to obtain vehicle speed and vehicle odometer data for a period of operation of the electrified vehicle, divide the vehicle speed and vehicle odometer data into N vehicle speed bins corresponding to different vehicle speeds, wherein N is an integer greater than one, determine an average road load power for the electrified vehicle based on the N vehicle speed bins, and estimate a remaining range of the electrified vehicle based on the historical average road load power.

In some implementations, the control system is configured to determine the average road load power by utilizing a road load force model with the N vehicle speed bins as one of a plurality of inputs. In some implementations, the control system is configured to determine the average road load power by utilizing the road force model with (i) an average of the vehicle speed within each of the N vehicle speed bins and (ii) ratios of the N vehicle speeds bins as two of the plurality of inputs.

In some implementations, the vehicle speed and vehicle odometer data is for a past or historical period of operation of the electrified vehicle. In some implementations, the average road load power is a historical average road load power for the electrified vehicle. In some implementations, the vehicle speed and vehicle odometer data are future or predicted data for operation of the electrified vehicle based on navigation data, and wherein the average road load power is a predicted average road load power for the electrified vehicle.

In some implementations, the control system is configured to calibrate N to achieve a desired accuracy for the N vehicle speed bins. In some implementations, the control system is configured to calibrate N to minimize a data transmission size or throughput of the N vehicle speed bins over a network. In some implementations, the dividing of the vehicle speed and vehicle odometer data into the N vehicle speed bins comprises applying a sliding window to the vehicle speed and odometer data to determine each of the N vehicle speed bins. In some implementations, N equals two.

According to another example aspect of the invention, another advanced forecasting and range estimation method for an electrified vehicle is presented. In one exemplary implementation, the advanced forecasting and range estimation method comprises providing an electrified powertrain of the electrified vehicle, the electrified powertrain including at least one electric motor and an energy storage system, obtaining, by a control system of the electrified vehicle, vehicle speed and vehicle odometer data for a period of operation of the electrified vehicle, dividing, by the control system, the vehicle speed and vehicle odometer data into N vehicle speed bins corresponding to different vehicle speeds, wherein N is an integer greater than one, determining, by the control system, an average road load power for the electrified vehicle based on the N vehicle speed bins, and estimating, by the control system, a remaining range of the electrified vehicle based on the historical average road load power.

In some implementations, the determining of the average road load power includes utilizing a road load force model with the N vehicle speed bins as one of a plurality of inputs. In some implementations, the determining of the average road load power includes utilizing the road force model with (i) an average of the vehicle speed within each of the N vehicle speed bins and (ii) ratios of the N vehicle speeds bins as two of the plurality of inputs.

In some implementations, the vehicle speed and vehicle odometer data is for a past or historical period of operation of the electrified vehicle In some implementations, the average road load power is a historical average road load power for the electrified vehicle. In some implementations, the vehicle speed and vehicle odometer data are future or predicted data for operation of the electrified vehicle based on navigation data, and wherein the average road load power is a predicted average road load power for the electrified vehicle.

In some implementations, the advanced forecasting and range estimation method further comprises calibrating, by the control system, a value of N to achieve a desired accuracy for the N vehicle speed bins. In some implementations, the advanced forecasting and range estimation method further comprises calibrating, by the control system, a value of N to minimize a data transmission size or throughput of the N vehicle speed bins over a network. In some implementations, the dividing of the vehicle speed and vehicle odometer data into the N vehicle speed bins comprises applying a sliding window to the vehicle speed and odometer data to determine each of the N vehicle speed bins. In some implementations, N equals two.

According to another example aspect of the invention, another advanced forecasting and range estimation system for an electrified vehicle is presented. In one exemplary implementation, the advanced forecasting and range estimation system comprises a set of non-propulsive vehicle systems of the electrified vehicle, the set of non-propulsive vehicle systems being configured to be powered by an energy storage system of an electrified powertrain of the electrified vehicle and a control system of the electrified vehicle, the control system being configured to obtain energy storage system energy data and vehicle odometer data, determine an energy per distance metric based on the energy storage system energy data and the vehicle odometer data, calculate a difference between a previously estimated remaining range of the electrified vehicle and the energy per distance metric, apply feedback control action based on the difference to generate a feedback correction value, and estimate a non-propulsive energy per distance metric based on a base non-propulsive power for the electrified vehicle and the feedback correction.

In some implementations, the control system is further configured to estimate the remaining range for the electrified vehicle based on the estimated non-propulsive energy per distance metric and a propulsive power demand of the electrified powertrain. In some implementations, the control system is further configured to apply a sliding window average to calculate the energy per distance metric.

In some implementations, the energy storage system comprises a high voltage battery pack or system and the energy per distance metric and the estimated non-propulsive energy per distance are state of charge (SOC) per unit distance. In some implementations, the control system is further configured to calculate an absolute value of the calculated energy per distance metric and then divide the absolute value by an inverse of the energy storage system energy data.

In some implementations, the control system is further configured to estimate the non-propulsive energy per distance metric based on a sum of the base non-propulsive power for the electrified vehicle and the feedback correction. In some implementations, the feedback control action is a proportional-integral (PI) control scheme.

In some implementations, the control system is further configured to estimate the propulsive power demand of the electrified powertrain based on a weighted blend of at least past or historical vehicle data and future or forecasted vehicle data. In some implementations, the control system is further configured to determine the future or forecasted vehicle data based on navigation data for a future trip of the electrified vehicle.

According to another example aspect of the invention, another advanced forecasting and range estimation method for an electrified vehicle is presented. In one exemplary implementation, the advanced forecasting and range estimation method comprises providing a set of non-propulsive vehicle systems of the electrified vehicle, the set of non-propulsive vehicle systems being configured to be powered by an energy storage system of an electrified powertrain of the electrified vehicle, obtaining, by a control system of the electrified vehicle, energy storage system energy data and vehicle odometer data, determining, by the control system, an energy per distance metric based on the energy storage system energy data and the vehicle odometer data, calculating, by the control system, a difference between a previously estimated remaining range of the electrified vehicle and the energy per distance metric, applying, by the control system, feedback control action based on the difference to generate a feedback correction value, and estimating, by the control system, a non-propulsive energy per distance metric based on a base non-propulsive power for the electrified vehicle and the feedback correction.

In some implementations, the advance forecasting and range estimation method further comprises estimating, by the control system, the remaining range for the electrified vehicle based on the estimated non-propulsive energy per distance metric and a propulsive power demand of the electrified powertrain. In some implementations, the advanced forecasting and range estimation method further comprises applying, by the control system, a sliding window average to calculate the energy per distance metric.

In some implementations, the energy storage system comprises a high voltage battery pack or system and the energy per distance metric and the estimated non-propulsive energy per distance are SOC per unit distance. In some implementations, the advanced forecasting and range estimation method further comprises calculating, by the control system, an absolute value of the calculated energy per distance metric and then dividing, by the control system, the absolute value by an inverse of the energy storage system energy data.

In some implementations, the advanced forecasting and range estimation method further comprises estimating, by the control system, the non-propulsive energy per distance metric based on a sum of the base non-propulsive power for the electrified vehicle and the feedback correction. In some implementations, the feedback control action is a PI control scheme.

In some implementations, the advanced forecasting and range estimation method further comprises estimating, by the control system, the propulsive power demand of the electrified powertrain based on a weighted blend of at least past or historical vehicle data and future or forecasted vehicle data. In some implementations, the advanced forecasting and range estimation method further comprises determining, by the control system, the future or forecasted vehicle data based on navigation data for a future trip of the electrified vehicle.

According to another example aspect of the invention, another advanced forecasting and range estimation system for an electrified vehicle is presented. In one exemplary implementation, the advanced forecasting and range estimation system comprises an electrified powertrain of the electrified vehicle, the electrified powertrain including at least one electric motor and an energy storage system and a control system of the electrified vehicle, the control system being configured to access navigation data for a future trip of the electrified vehicle, access past or historical data for past trips of the electrified vehicle, determine a predicted road load power based on the navigation data, determine a historic average road load power based on the past or historical data, calculate a weighted blend of the predicted road load power and the historic average road load power to obtain an estimation of a propulsive energy consumption rate for the electrified vehicle, calculate an estimation for a non-propulsive energy consumption rate based on base power consumption and feedback controller action, and estimate a final remaining range of the electrified vehicle based on the estimated propulsive and non-propulsive energy consumption rates.

In some implementations, the weighted blend more heavily weights the predicted road load power over historic road load power data if dynamic road load and the navigation data are sufficiently present. In some implementations, the weighted blend fully weights the navigation data and the predicted load power when the navigation data is determined to be sufficient.

In some implementations, the weighted blend more heavily weights the past or historical data and the historic average road load power when the navigation data is inaccessible or is determined to be insufficient. In some implementations, the navigation data is determined to be inaccessible or insufficient based on communication by the control system with a remote server configured to provide the navigation data.

In some implementations, the control system is configured to determine the predicted road load power based on both the navigation data and a dynamic road load. In some implementations, the control system is configured to characterize vehicle speed and road grade for the future trip based on the navigation data. In some implementations, the control system is further configured to predict future average road load power based on dynamic road load and navigation data to account for changes in vehicle demand energy.

In some implementations, the navigation data further comprises weather information and the control system is further configured to offset the energy consumption rate based on the weather information.

According to another example aspect of the invention, another advanced forecasting and range estimation method for an electrified vehicle is presented. In one exemplary implementation, the advanced forecasting and range estimation method comprises providing an electrified powertrain of the electrified vehicle, the electrified powertrain including at least one electric motor and an energy storage system, accessing, by the control system, navigation data for a future trip of the electrified vehicle, accessing, by the control system, past or historical data for past trips of the electrified vehicle, determining, by the control system, a predicted road load power based on the navigation data, determining, by the control system, a historic average road load power based on the past or historical data, calculating, by the control system, a weighted blend of the predicted road load power and the historic average road load power to obtain an estimation of a propulsive energy consumption rate for the electrified vehicle, calculating, by the control system, an estimation for a non-propulsive energy consumption rate based on base power consumption and feedback controller action, and estimating, by the control system, a final remaining range of the electrified vehicle based on the estimated propulsive and non-propulsive energy consumption rates.

In some implementations, the weighted blend more heavily weights the predicted road load power over historic road load power data if dynamic road load and the navigation data are sufficiently present. In some implementations, the weighted blend fully weights the navigation data and the predicted load power when the navigation data is determined to be sufficient.

In some implementations, the weighted blend more heavily weights the past or historical data and the historic average road load power when the navigation data is inaccessible or is determined to be insufficient. In some implementations, the navigation data is determined to be inaccessible or insufficient based on communication by the control system with a remote server configured to provide the navigation data.

In some implementations, the determining of the predicted road load power is based on both the navigation data and a dynamic road load. In some implementations, the advanced forecasting and range estimation method further comprises characterizing, by the control system, vehicle speed and road grade for the future trip based on the navigation data. In some implementations, the advanced forecasting and range estimation method further comprises dynamically relating, by the control system, the dynamic road load and the vehicle speed to account for changes in vehicle demand energy.

In some implementations, the navigation data further comprises weather information and the advanced forecasting and range estimation method further comprises offsetting, by the control system, the energy consumption rate based on the weather information.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIGS. 1A-1B are functional block diagrams of an electrified vehicle and an example advanced forecasting and remaining range estimation system according to the principles of the present application;

FIGS. 2A-2D are functional block diagrams of example system architectures for the advanced forecasting and range estimation system according to the principles of the present application; and

FIG. 3 is a flow diagram of an example advanced forecasting and range estimation method for an electrified vehicle according to the principles of the present application.

### DESCRIPTION

While a customer is driving an electrified vehicle, one of the key pieces of information given to the customer is the remaining range available based on the current fuel level or state of charge (SOC), depending on the powertrain configuration of the electrified vehicle (battery electric vehicle, or BEV, plug-in hybrid electric vehicle, or PHEV, etc.). The remaining range calculation is, at least in part, based on vehicle propulsion controller inputs. Remaining range accuracy is of critical importance for customer satisfaction, enabling better planning by the customer, avoiding stranded situations, and resulting in greater peace of mind. Accuracy of the range estimation can be greatly improved if future energy consumption is modeled and included. However, modeling future energy consumption is very difficult and relies on many different factors. Thus, an opportunity exists for improvement in the relevant art. Accordingly, an improved strategy for advanced forecasting and range estimation for electrified vehicles is presented herein. This strategy involves a unique blending of past/historical energy consumption data with future/forecasted energy consumption data, which is difficult to model and relies on many different factors. This strategy also includes other unique sub-components or aspects of computing the various parameters that are used in the final vehicle energy consumption blending and vehicle range calculation.

Vehicle energy consumption can be divided into propulsive and non-propulsive components of the vehicle's overall energy consumption. The propulsive energy consumption can be predicted based on dynamic road load component and a navigation/horizon inputs. Road load power is computed based on an estimation model of the road load force, which may or may not be dynamic. This computation can also involve a unique binning process whereby vehicle speed data is discretized such that it is easier to analyze and transmit (e.g., between the vehicle and the cloud). Thereafter, power delivery efficiency terms can be applied to translate road load power into vehicle demand power requirements. Non-propulsive power is also calculated in a unique manner. The non-propulsive power estimation is based on feedback correction and stems from an energy metric corresponding to remaining energy level of the vehicle system (e.g., in BEVs, high voltage battery state of charge, or SOC). This feedback correction can be further augmented with directly known power consumption elements and can include, for example only, non-propulsive systems such as heating/ventilation/air conditioning (HVAC), infotainment units (e.g., displays), and the like.

Finally, the blended energy consumption rate is calculated based on past/historical information and, when available, future/predictive information. To begin, the availability of navigation/horizon data (e.g., cloud connectivity and a set route) is determined. For example, a route may be unavailable when the customer has not specified an endpoint and/or navigation information may be unavailable when the vehicle does not have a connection with a cloud-based service. When the navigation data is available, the trip can be characterized by its speed and road grade (e.g., based on dynamic road load). The horizon data could also extend to include weather attributes (temperature, precipitation, etc.), traffic conditions, or other attributes that affect eh vehicle mission profile. The relationship between road load force and vehicle mission profile is treated dynamically to account for changes in vehicle demand energy (e.g., mass, aerodynamics, tire pressure, etc.). All of these factors affect a blending ratio for future versus past information, where the blending ratio indicates a confidence in the future/predicted energy consumption, which is initially prioritized over past/historical energy consumption. The blending ratio for these two rates can also be updated dynamically based on the availability of information.

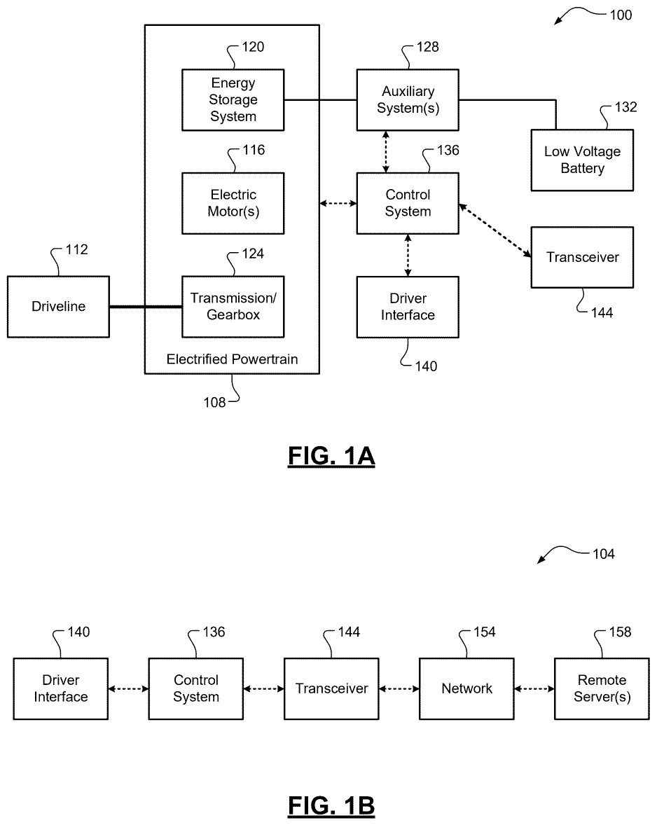

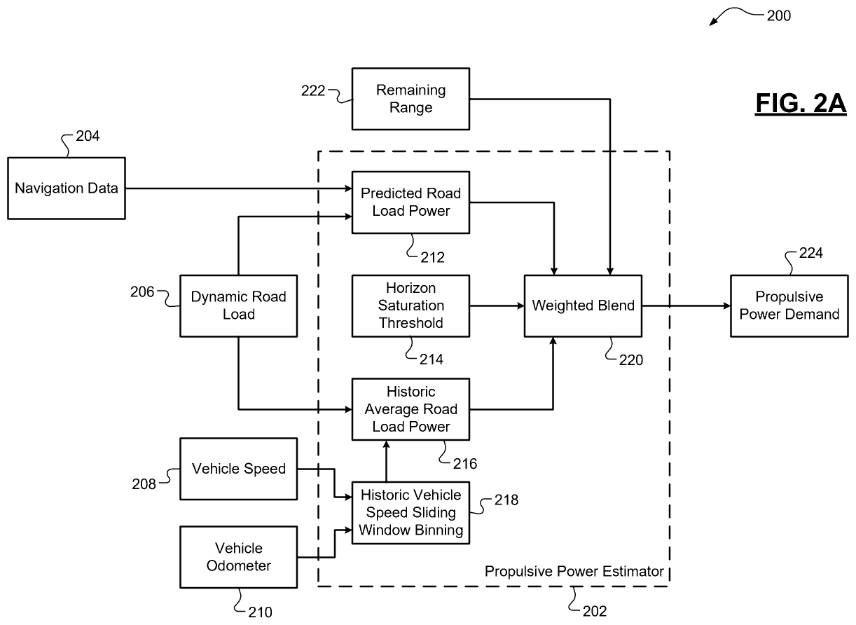

Referring now to FIGS. 1A-1B, functional block diagrams of an electrified vehicle 100 and an example advanced forecasting and range estimation system 104 according to the principles of the present application is illustrated. The electrified vehicle 100 (also “vehicle 100” herein) generally comprises an electrified powertrain 108 configured to generate and transfer torque to a driveline 112 for propulsion. As previously mentioned, the electrified powertrain 108 could have many different configurations (BEV, PHEV, etc.). As shown, the electrified powertrain 108 includes one or more electric motors 116 configured to generate mechanical torque and powered by electrical energy from an energy storage system (ESS) 120. The ESS 120 could include a high voltage battery pack or system, a fuel cell system (e.g., a hydrogen or H2 fuel cell system), or some combination thereof. The electrified powertrain 108 could also include an internal combustion engine (not shown) configured to generate mechanical torque by combusting a mixture of air and fuel (gasoline, diesel, etc.). Propulsive torque is transmitted to the driveline 112 via a transmission or gearbox 124 and non-propulsive power could be supplied to auxiliary vehicle systems 128, which could perhaps further be associated with a low voltage (e.g., 12V) battery system 132.

A controller or control system 136 controls operation of the electrified vehicle 100, which primarily includes controlling the electrified powertrain 108 to generate a sufficient amount of propulsive torque to satisfy a driver torque request provided by a driver via a driver interface 140 (e.g., an accelerator pedal). While shown as a separate component, it will be appreciated that the driver interface 140 could be one of the auxiliary vehicle systems 128 powered by non-propulsive torque or power. The control system 136 is configured to perform at least a portion of the techniques of the present application. This involves the control system 136 determining a remaining range of the electrified vehicle 100, via calculations based on past/historical energy consumption (e.g., stored locally or remotely) and based on predicted/future energy consumption that is forecasted based on various criteria as explained in greater detail below. As shown in FIG. 1B, the control system 136 is configured to communicate via a transceiver 144 and a network 154 (e.g., a cellular or satellite network) to receive information (navigation information, weather information, etc.) from one or more remote serves 158. For example, these server(s) 158 could be managed by an original equipment manufacturer (OEM) of the electrified vehicle 100 or a third-party service provider (e.g., accessible via API calls).

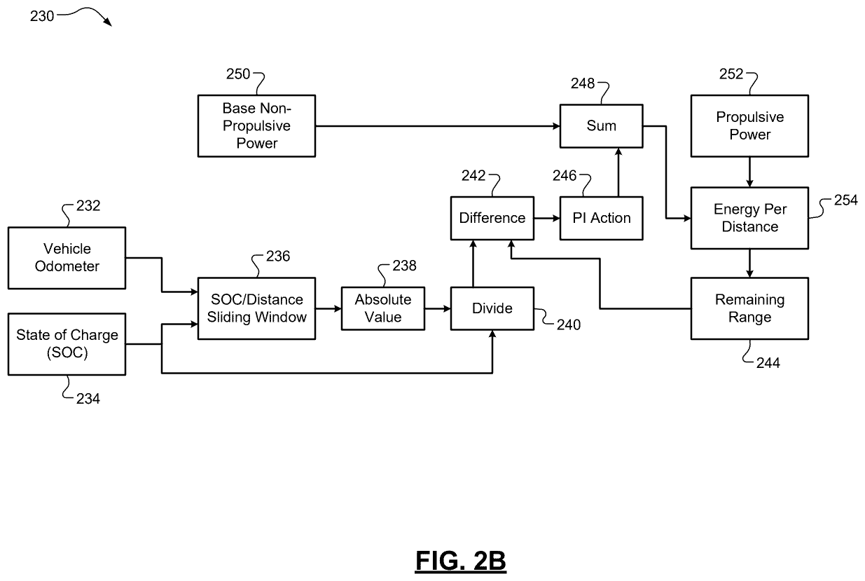

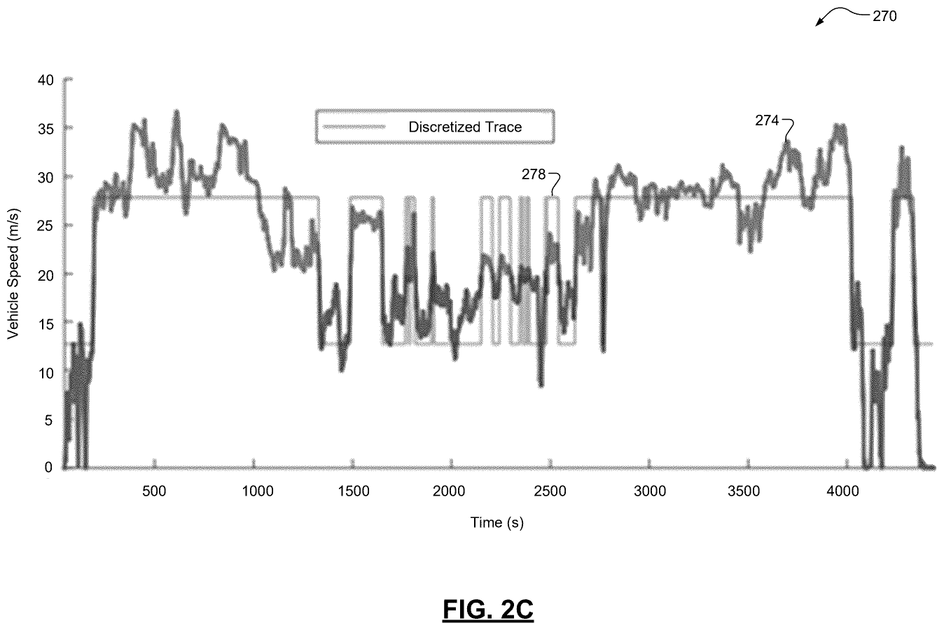

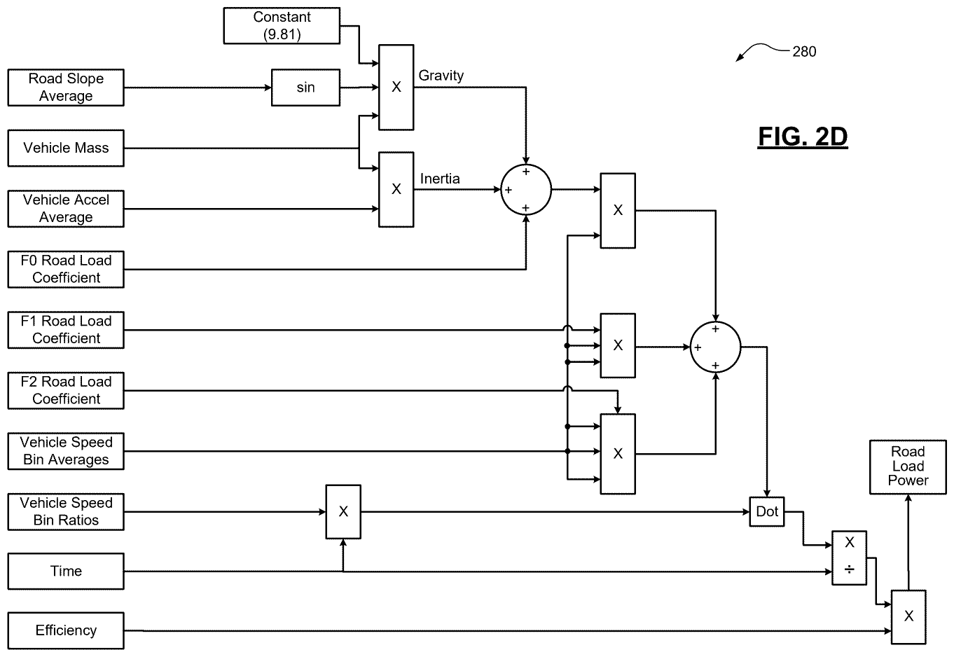

Referring now to FIG. 2A-2C and with continued reference to FIGS. 1A-1B, functional block diagrams of example system architectures 200, 250 for the advanced forecasting and range estimation system 104 according to the principles of the present application are illustrated. As previously discussed, the estimation of the remaining range of the electrified vehicle 100 is based on a combination of two power components, both of which can widely vary during different operating periods of the electrified vehicle 100. The first power component is (1) propulsive power, which represents the power consumed by the propulsive systems of the electrified vehicle 100, and the second power component is (2) non-propulsive power, which represents the power consumed by the non-propulsive systems of the electrified vehicle 100 (e.g., the auxiliary system(s) 128, components of the driver interface 140, such as a display/infotainment system, the transceiver 144 and communication via the network 154, and the like). Both of these power components can be estimated based on some combination or blending of past/historical and future/forecasted data, which will now be described in greater detail.

Referring first to FIG. 2A, an example system architecture 200 for a weighted blending of past or historical data and future or forecasted data to determine a propulsive power demand according to the principles of the present application is illustrated. As shown, navigation/horizon data 204 (grade/slope, surface type, speed limits, traffic data, etc.), if available, is fed to a predicted road load power determination block 212, along with a dynamic road load 206, which represents a road load force estimation model that may or may not be dynamic. This dynamic road load 206 also supports calculation of historic road load power in 216, dependent on past vehicle speed 218. The horizon saturation threshold indicates a distance or time at which the future or forecasted data should be trusted or relied upon over past or historical data (i.e., not exceedingly far into the future). The final weighted blending also depends on the current remaining range estimation of the electrified vehicle 100, which will now be discussed in greater detail.

Referring now to FIG. 2B and with continued reference to FIG. 2A, a functional block diagram of an example system architecture 230 for estimating the remaining range 222 of the electrified vehicle 100 according to the principles of the present application is illustrated. While a customer is driving a vehicle, one of the key pieces of information given to the customer is the remaining range available given the current fuel level or SOC (depending on vehicle type). The remaining range calculation is, at least in part, calculated based on vehicle propulsion controller inputs. Remaining range accuracy is of critical importance for customer satisfaction, both for peace of mind and to avoid stranded customers. Nearly all existing or conventional methods for remaining range calculation are centered around energy consumption rate, without inclusion of any correction mechanism or other term not based on energy consumption. The illustrated method 230 is a method for implementing feedback control to reduce error in battery electric vehicle remaining range estimation over the course of driving trip. The method 230 relies on computing the power consumption of the ESS 120 (e.g., SOC of a high voltage battery pack or system) per vehicle distance traveled (hereinafter, “SOC/distance”). While SOC is specifically referenced, it will be appreciated that the ESS 120 could include other components, such as a fuel cell system, or a combination of components. First, SOC/distance must be computed. this can be achieved in different ways.

After SOC/distance is obtained, use the information to compute an alternative estimate for range. This should most likely be over a historical window that differs from other window-based computations occurring in support of range estimation, but the window size can be calibrated to suit the needs of the platform. As shown, vehicle distance or odometer data 232 and SOC or similar energy consumption data 234 for the ESS 120 is obtained (e.g., from respective physical or virtual sensors) and provided to an SOC/distance sliding window computation block 236, which computes the SOC/distance metric over a calibratable window. The absolute value of the SOC/distance is taken at block 238, and the result is divided by the SOC data 234 at block 240. The result of block 240, secondary range estimation, has the primary remaining range 244 subtracted therefrom at block 242 and feedback (e.g., proportional-integral, or PI) control action 246 is taken to improve the remaining range estimation computed. In other words, SOC/distance is employed as a feedback mechanism to offset downstream computations towards a more accurate range estimation. The output of the PI/control action block 246 is combined with a base non-propulsive power 250 at block 248 to calculate the final energy/distance metric at 254, which is also affected by the propulsive power 252 as previously discussed. The final energy/distance metric 254 is used to more accurately estimate the remaining range 244 of the electrified vehicle 100.

Referring again to FIG. 2A, other inputs to the propulsive power estimator 202 include vehicle speed 208 and a vehicle odometer 210, which could be sensors of the auxiliary system(s) 128. Based on the vehicle speed and odometer reading, a historic vehicle speed sliding window binning block 218 performs a discretization process of the vehicle speed data to obtain discretized vehicle speed data that is much less noisy and computationally lighter. FIG. 2C illustrates an example plot 270 of discretized vehicle speed data in two bins (the high and low levels of the discretized trace 278), as derived from noisy vehicle speed data 274 (e.g., in meters per second, or m/s) over a period of time (~4500 s), which could be either in the past (historical data) or in the future (forecasted data). As can be seen, the discretized trace 278 is much simpler and while also providing data that is more easily usable in calculations and for transmission between devices. The number of bins (e.g., N, where N is an integer value greater than one) can be calibrated for a desired level of accuracy while not greatly impacting the computational requirements.

After discretization is achieved, the road load power can be modeled with vehicle speed and road grade as inputs at blocks 218 and 216. FIG. 2D, for example, illustrates a diagram of an example calculation scheme 280 for modeling the road load power as described. It will be appreciated that this calculation scheme is merely only example calculation and that the road load equation could be slightly different (e.g., from the classical road load equation) depending on the particular application. The illustrated road load power calculation in FIG. 2D has a variety of inputs, including, but not limited to, road slope average, vehicle mass, average vehicle acceleration, different road load coefficients, the vehicle speed bin averages and ratios, time, and efficiency. Based on these inputs, a road load power can be calculated using the various illustrated intermediary steps or calculations.

As shown in FIG. 2D, a sine function (sin) is taken on the road slop average, which is multiplied along with vehicle mass and a gravity constant (e.g., 9.81 m/s²) to obtain a force component due to gravity. Average vehicle acceleration is also multiplied by vehicle mass to obtain a force component due to inertia. These force components are then summed along with a first coefficient (F0 or A), which represents a constant road load force coefficient (e.g., in Netwons, or N). This sum is then multiplied by vehicle speed to produce the zeroth order power estimation. The first and second order power estimations depend on F1 and F2 road load coefficients, respectively, as well as vehicle speed. The three power estimations are then summed. If vehicle speed discretization is employed, the time-or distance-based bin proportionality is applied in the dot product to properly sum the power across all bins. The dot product output is multiplied by an inverse of time to properly re-scale the power, and the result is then multiplied by the efficiency metric to obtain the final road load power estimation.

Referring again to FIG. 2A, the weighted blending block 220 receives the above-described remaining range estimation 222, the predicted road load power 212, the horizon saturation threshold 214, and the historic average road load power 216. The weighted blending block 220 performs a weighted blending of these various inputs to determine a final propulsive power demand 224 as an output. This weighted blending, for example, could initially favor the future or forecasted data more heavily, as it cannot be assumed that the electrified vehicle 100 will even remotely follow the past or historical data. For example, as previously discussed herein, the past or historical data could be based on very different weather conditions, which could substantially affect how the electrified vehicle 100 consumes power during operation. In addition, it cannot be assumed that the driver will behave or control the electrified vehicle 100 in the same way as reflected by the past or historical data. For example, the driver could have previously been driving to or from work on a relatively flat highway, whereas the driver's current trip could involve towing a heavy payload through a mountainous region, which would be very different than the past or historical data for an unloaded vehicle on a relatively flat highway. If the future or forecasted data is limited or of poor quality (or is totally unavailable), however, then the weighted blending 220 could more strongly or significantly favor the past or historical data.

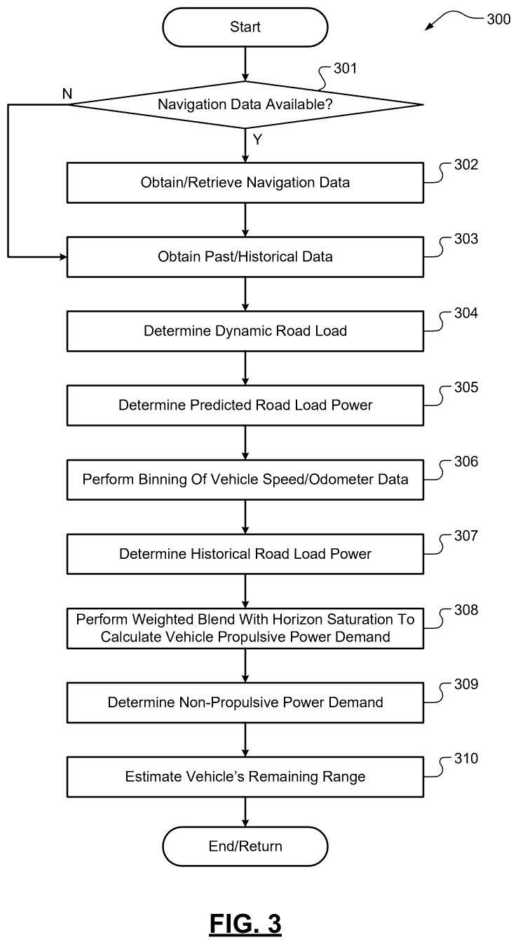

Referring now to FIG. 3, a flow diagram of an example advanced forecasting and remaining range estimation method for an electrified vehicle according to the principles of the present application are illustrated. While the description of this method 300 specifically references the electrified vehicle 100 and its components for descriptive and illustrative purposes, it will be appreciated that this method 300 could be applicable to any suitably configured electrified vehicle (e.g., having an electrified powertrain with one or more electric motors and an ESS, such as a high voltage battery pack or system). It will also be appreciated that this method 300 includes various sub-methods as previously described herein and as illustrated by FIGS. 2A-2D. The method 300 begins at 301 where the control system 136 determines whether navigation data for the current/future trip of the vehicle 100 is accessible. This could include determining, for example, that sufficient quality navigation data is available and that the connection with the remote server(s) 158 via the network 154 is sufficient. The amount/quality of the navigation data affects the weighted blend to determine the propulsive power demand of the electrified vehicle 100 as discussed herein. In some cases, there could be no navigation data accessible due to the electrified vehicle 100 traveling in an unknown area (e.g., where there is no navigation data) or the navigation data being inaccessible via the network 154. When unavailable, the method 300 can still continue to 303 and the weighted blend will more greatly or fully favor/weight the past/historical vehicle data over any future/forecasted data. When the navigation data is accessible and of sufficient quality, it can be retrieved by the control system 136 via the network 154 at 302.

At 303, the historical/past vehicle data is obtained, which could be locally from a memory, remotely via the network 154, or some combination thereof. At 304, the control system 136 determines the dynamic road load (e.g., using the road load force model). At 305, the control system 136 determines the predicted road load power based on the dynamic road load and the navigation data, if accessible. At 306, the control system 136 performs binning (e.g., sliding window binning) of the past or historical vehicle speed/odometer data to obtain binned vehicle speed/odometer data that is easier to process and also transmit. At 307, the control system 136 determines a historical road load power based on the binned vehicle speed/odometer data and the road load force model (e.g., see FIG. 2D). At 308, the control system 136 performs or calculates the weighted blend with the horizon saturation to obtain a propulsive power demand of the electrified vehicle. At 309, the control system 136 determines the non-propulsive power demand of the electrified vehicle 100. Finally, at 310, the propulsive and non-propulsive power demands can then be used to more accurately estimate the energy consumption rate and the remaining range of the electrified vehicle 100. The method 300 then ends.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An advanced forecasting and range estimation system for an electrified vehicle, the advanced forecasting and range estimation system comprising:
a set of non-propulsive vehicle systems of the electrified vehicle, the set of non-propulsive vehicle systems being configured to be powered by an energy storage system of an electrified powertrain of the electrified vehicle; and
a control system of the electrified vehicle, the control system being configured to:
obtain energy storage system energy data and vehicle odometer data;
determine an energy per distance metric based on the energy storage system energy data and the vehicle odometer data;
calculate a difference between a previously estimated remaining range of the electrified vehicle and the energy per distance metric;
apply feedback control action based on the difference to generate a feedback correction value; and
estimate a non-propulsive energy per distance metric based on a base non-propulsive power for the electrified vehicle and the feedback correction.

2. The advanced forecasting and range estimation system of claim 1, wherein the control system is further configured to estimate the remaining range for the electrified vehicle based on the estimated non-propulsive energy per distance metric and a propulsive power demand of the electrified powertrain.

3. The advanced forecasting and range estimation system of claim 1, wherein the control system is further configured to apply a sliding window average to calculate the energy per distance metric.

4. The advanced forecasting and range estimation system of claim 3, wherein the energy storage system comprises a high voltage battery pack or system and the energy per distance metric and the estimated non-propulsive energy per distance are state of charge (SOC) per unit distance.

5. The advanced forecasting and range estimation system of claim 3, wherein the control system is further configured to calculate an absolute value of the calculated energy per distance metric and then divide the absolute value by an inverse of the energy storage system energy data.

6. The advanced forecasting and range estimation system of claim 5, wherein the control system is further configured to estimate the non-propulsive energy per distance metric based on a sum of the base non-propulsive power for the electrified vehicle and the feedback correction.

7. The advanced forecasting and range estimation system of claim 1, wherein the feedback control action is a proportional-integral (PI) control scheme.

8. The advanced forecasting and range estimation system of claim 1, wherein the control system is further configured to estimate the propulsive power demand of the electrified powertrain based on a weighted blend of at least past or historical vehicle data and future or forecasted vehicle data.

9. The advanced forecasting and range estimation system of claim 8, wherein the control system is further configured to determine the future or forecasted vehicle data based on navigation data for a future trip of the electrified vehicle.

10. An advanced forecasting and range estimation method for an electrified vehicle, the advanced forecasting and range estimation method comprising:
providing a set of non-propulsive vehicle systems of the electrified vehicle, the set of non-propulsive vehicle systems being configured to be powered by an energy storage system of an electrified powertrain of the electrified vehicle;
obtaining, by a control system of the electrified vehicle, energy storage system energy data and vehicle odometer data;
determining, by the control system, an energy per distance metric based on the energy storage system energy data and the vehicle odometer data;
calculating, by the control system, a difference between a previously estimated remaining range of the electrified vehicle and the energy per distance metric;
applying, by the control system, feedback control action based on the difference to generate a feedback correction value; and
estimating, by the control system, a non-propulsive energy per distance metric based on a base non-propulsive power for the electrified vehicle and the feedback correction.

11. The advanced forecasting and range estimation method of claim 10, further comprising estimating, by the control system, the remaining range for the electrified vehicle based on the estimated non-propulsive energy per distance metric and a propulsive power demand of the electrified powertrain.

12. The advanced forecasting and range estimation method of claim 10, further comprising applying, by the control system, a sliding window average to calculate the energy per distance metric.

13. The advanced forecasting and range estimation method of claim 12, wherein the energy storage system comprises a high voltage battery pack or system and the energy per distance metric and the estimated non-propulsive energy per distance are state of charge (SOC) per unit distance.

14. The advanced forecasting and range estimation method of claim 13, further comprising calculating, by the control system, an absolute value of the calculated energy per distance metric and then dividing, by the control system, the absolute value by an inverse of the energy storage system energy data.

15. The advanced forecasting and range estimation method of claim 14, further comprising estimating, by the control system, the non-propulsive energy per distance metric based on a sum of the base non-propulsive power for the electrified vehicle and the feedback correction.

16. The advanced forecasting and range estimation method of claim 10, wherein the feedback control action is a proportional-integral (PI) control scheme.

17. The advanced forecasting and range estimation method of claim 10, further comprising estimating, by the control system, the propulsive power demand of the electrified powertrain based on a weighted blend of at least past or historical vehicle data and future or forecasted vehicle data.

18. The advanced forecasting and range estimation method of claim 17, further comprising determining, by the control system, the future or forecasted vehicle data based on navigation data for a future trip of the electrified vehicle.
